(19) United States
(12) Patent Application Publication
(10) Pub. No.: US 2002/0054540 A1
(43) Pub. Date: May 9, 2002

(54) Process and device for reproducing the current time

(76) Inventor: Reinhard Wiesemann, Essen (DE)

Correspondence Address: NIXON PEABODY, LLP, 8180 GREENSBORO DRIVE, SUITE 800, MCLEAN, VA, 22102, US

(21) Appl. No.: 09/822,857

(22) Filed: Apr. 2, 2001

(30) Foreign Application Priority Data
Mar. 31, 2000 (DE) 100 16 089.1
Feb. 17, 2001 (DE) 101 07 602.9

(51) Int. Cl. G04B 47/00; G04C 17/00; G04B 19/00; G04B 25/00

(52) U.S. Cl. 368/12; 368/223

(57) ABSTRACT

The invention relates to a process and a device for reproducing the current time using at least one reproduction element in which the state of the reproduction elements is assigned to the current time. As claimed in the invention the reproduction of the current time takes place especially graphically in that the states of the reproduction elements (5, 6, 7, 9, 10, 11, 12, 15, 16, 17, 18, 19, 21, 22, 23, 26) reproduce the ambient states matched to the actual environment.

The invention relates to a process and a device for reproducing the current time using at least one reproduction element in which the state of the reproduction elements is assigned to the current time.

In the processes and devices known from the prior art for reproduction of the current time, reproduction takes place via reproduction elements which reproduce at least the current clock time and generally in addition the current date via pointer assigned to a numerical sheet or the direct display of digits as the reproduction elements. This type of reproduction or display of the current time is based on the abstract subdivision of the time into seconds, minutes, hours, days, weeks, months, and years.

As a result of the use of the described abstract time division the known processes and devices for reproducing the current time lack intuitive access. There is often a desire for especially graphic reproduction or display of the current time with an attractive configuration of the reproduction elements.

Proceeding from the above described problem the object of this invention is to make available a process and a device for reproducing the current time which represents the current time graphically without interposition of an abstraction process.

According to the first teaching of the invention, the aforementioned object for a process for reproducing the current time is achieved in that the states of the reproduction elements reproduce the ambient states matched to the actual environment. The teaching as claimed in the invention enables the user or the viewer direct intuitive access to the current time.

The concept of time should be understood here in its most comprehensive sense. It can stand for the clock time, the day, the month, the season, the year and so forth. The ambient states adapted to the actual environment of the user are defined as the ambient states in the most general sense. They are both physical ambient states, i.e. for example ambient states matched to different geographical zones, and also mental-moral ambient states for example deriving from membership in various cultural circles. In addition, the ambient states can be matched to a dense or less densely settled environment. In addition, the ambient states can also be matched quite individually to the user. It is conceivable for example that special times, such as for example, Easter, Christmas, New Year's Eve, the birthday of the user, etc. are reproduced separately according to the process as claimed in the invention.

The most important ambient states can be represented according to one embodiment of the process according to the first teaching of the invention in that the reproduction elements depending on the current time reproduce optical, acoustical, physical and/or scent effects. Examples are for instance that in a model world, model components, such as figures, vehicles, mechanical effects, etc. move at fixed times in a certain way and/or approach certain positions. Smoke, vapors or acoustic effects can also be produced depending on the time.

Graphic access to the current time is especially promoted by the reproduction elements simultaneously reproducing ambient situations which are assigned depending on the current time. To do this for example times such as a morning atmosphere, Sunday/workday, summer/winter etc. will be graphically reproduced by light effects and by “automatic scenery change” in the model world at the same time.

According to a second teaching of the invention the aforementioned object is achieved for a device for reproducing the current time in that the ambient states matched to the current ambient states can be reproduced by the reproduction elements. Regarding the advantages of the embodiment of a device for reproducing the current time with the described features reference is made to the advantages of the process according to the first teaching of the invention.

For example, to reduce wear, according to the first embodiment of the second teaching of the invention for activation of the reproduction element there is a proximity sensor so that the reproduction elements only reproduce the matched ambient states when at least one individual is in the vicinity of the device for reproducing the current time.

To keep the reproduction of the matched ambient states current, it is advantageous if according to another embodiment there is a data interface for updating the EDP triggering of the reproduction elements. In this way the device can either itself call up information, for example from the Internet, or can be actively supplied from the outside with information for changing its reproduction functions and/or reproduction content. In this way for example in the model world as claimed in the invention not only the current time, but also the weather and any other interesting data from the real world can be displayed.

In particular the use of EDP triggering enables use of display panels, poster boards, or the like within the model world for display of special relationships at the current time and/or for other purposes. Thus for example a poster wall in the model world can contain a miniaturized display or projection on which for example advertising of companies or stock quotes or the weather can be displayed.

One development of the device which is especially advantageous with respect to setting up a device according to the second teaching of the invention is ensured by the housing of the device being made to be matched to the standard dimensions of the position of the record player of a HiFi rack. Because the record player has largely disappeared from living rooms of households in recent years, its place above the remaining HiFi components has become free. This location and its adaptation to the configuration of conventional record players are ideal for setting up a device as claimed in the second teaching of the invention. The base surface is largely standardized with roughly 43×43 cm and it is possible to place a foldable transparent cover over the model world as claimed in the invention by which it is protected from dirt, etc. as for a record player. In addition there is a power terminal and access to all audio/video terminals at this site. A connection of the audio/video system to the model can be used to advantage and can be used both actively—the model delivers audio and/or video signals to the HiFi system—and also passively—the system delivers audio and/or video signals which influence the model in a certain way.

Alternatively to the above described development the device as claimed in the invention can be configured by the housing being made to be adapted to wearing on a bracelet. In view of the miniaturized production of three-dimensional articles which is possible within the framework for example of microsystems engineering and the possibilities of display of ambient states on miniaturized displays, the possibility arises for miniaturizing the device as claimed in the invention such that it can be worn in the manner of a wristwatch on the wrist.

In addition, an additional conventional time display inside or outside of the model world can be added to the device as claimed in the invention. The arrangement of a simulated sundial within the model world is also conceivable. This yields the possibility for the user to make accessible the current time, in addition to the intuitive, graphic, but somewhat inaccurate reproduction as claimed in the invention, exactly or at least relatively exactly.

There are now a host of possibilities for embodying and developing the process as claimed in the invention and the device as claimed in the invention. To do this reference is made for example on the one hand to the claims subordinate to claims 1 and 4 and on the other hand to the description of one preferred embodiment in conjunction with the drawings.

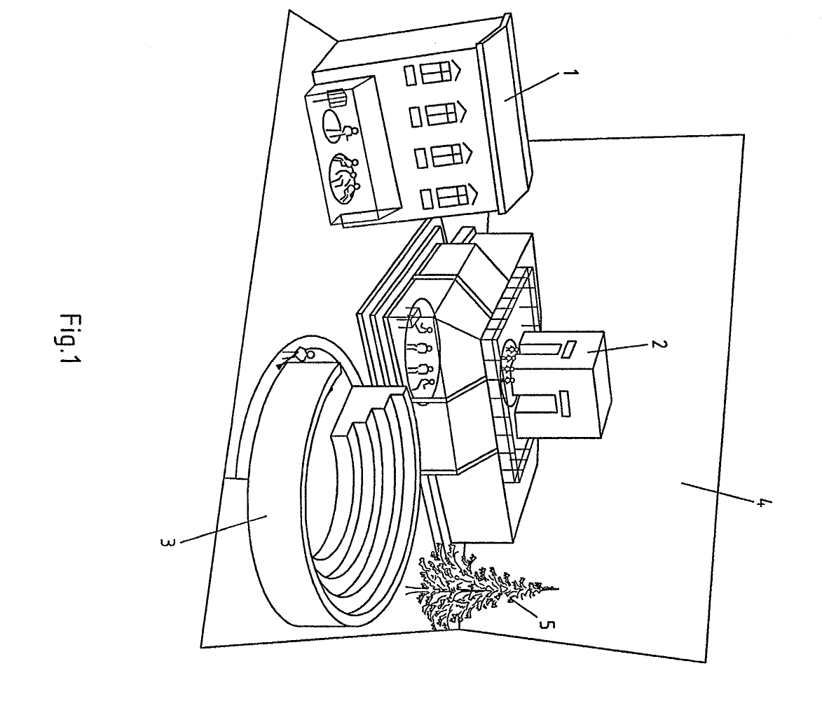

FIG. 1 shows a perspective view of one embodiment of a device for reproducing the current time,

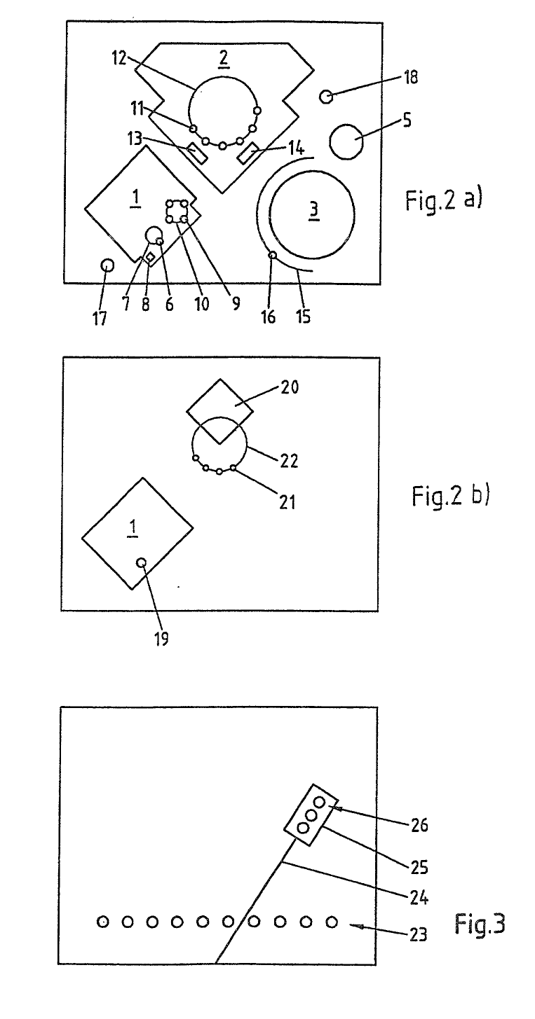

FIGS. 2a), b) schematically show the arrangement of the reproduction elements of the embodiment of a device for reproducing the current time in aspect and

FIG. 3 schematically shows the arrangement of the reproduction elements in the embodiment of a device for reproducing the current time in a second view.

The embodiment of the device as claimed in the invention for reproducing the current time shown in FIG. 1 is one such device which is based on an episode from the novel Momo by Michael Ende. The elements of this device are the house of the barber Fusi 1, the gray house 2 and the amphitheater 3. Behind the scenery formed essentially from these elements is the horizon 4. In addition, in the vicinity of the amphitheater 3 there is a fir tree 5.

The reproduction elements moving in the scenery just described are described below with reference to FIGS. 2 and 3. FIG. 2a) shows an aspect of the scenery in the lower plane, i.e. in roughly the plane of the surrounding area, and the reproduction elements moving on this plane. In the house of the barber Fusi 1 the barber Fusi 6 is moving on a first circular path 7. The movement of the barber Fusi 6 takes place via a stepping motor which is located underneath the plane shown in FIG. 2a and which moves a disk on which the barber Fusi 6 is attached. Here the barber Fusi moves between three positions. In the first position the barber Fusi 6 is looking at a cage 8 containing a budgerigar. In the second position the barber Fusi 6 is looking out of the window of his barbershop. In the third position the barber Fusi 6 is turning to customers 9 who can move on a second circular path 10. There are four customers 9. These customers 9 optically differ clearly from one another.

In the gray house 2 six gray customers 11 are moving on a third circular path 12 between two tables 13, 14 of a fast-food restaurant at which they are being served. The gray customers 11 do not optically differ from one another.

On the fourth circular path 15 the street-sweeper Beppo 16 is moving on a semicircle around the amphitheater 3. In doing so the street-sweeper Beppo 16 is attached to one part of a circular plate which is made in its edge area as a sidewalk and is clean in the working direction behind the street-sweeper Beppo 16 and is dirty in front of the street-sweeper Beppo 16. Finally, on the first plane in the vicinity of the house of the barber Fusi 1 there is a first streetlight 17 and in the vicinity of the gray house 2 there is a second streetlight 18.

On the second plane of the scenery shown in FIG. 2b) there is a light 19 in the house of the barber Fusi 1. On the roof of the gray house 2 is the so-called children's day care 20. Four children 21 are moving partially on the roof of the gray house 2 partially in the children's day care 20 on a fifth circular path 22. This motion on the fifth circular path 22 like all other motion on circular paths is triggered via a stepping motor. The horizon 4 shown in FIG. 3 in a front view has various illumination elements behind a translucent screen which is not shown. These illumination elements consist on the one hand of light emitting diodes 23 which can produce a shimmer on the horizon. In addition, on one arm 24 on a support 25 there are light emitting diodes 26 of different colors by which the sun can be shown in different colors. Therefore there are red, orange and white light emitting diodes. The circular path of the sun on the horizon is simulated via the motion of the arm 24.

One possible progression for simulation of ambient states using the embodiment shown is illustrated in the following table.

| | | | | Fusi's | 6 Gray | | |
|---|---|---|---|---|---|---|---|
| | Shimmer on the | | Fusi | Customers | Customers | Christmas Tree Only 1^{st} | |
| | horizon (23) | Sun (24, 25, 26) | (6, 7) | (9, 10) | (11, 12) | Advent to 6.1. (5) | Other |
| 0:00 | | | | | | | Beppp's return (15, 16) |
| 1:00 | | | | | | | |
| 2:00 | | | | | | | |
| 3:00 | | | | | | | |
| 4:00 | Quite weak | | | | | | |
| 5:00 | Weak | | | | | | |
| 6:00 | | Red | | | | | |
| 7:00 | Off | Red-yellow | Budgerigar | | | | Streetlights off (17, 18) |
| 7:30 | | | Window | | | | |
| 8:00 | | White | At the | Customer 1 | 1 Fast-food | Off | Beppo start (15, 16) |
| | | | customer | | Restaurant | | |
| 8:15 | | | | | 2 Fast-food | | |
| | | | | | Restaurant | | |
| 8:30 | | | | Customer 2 | 3 Fast-food | | |
| | | | | | Restaurant | | |
| 8:45 | | | | | 4 Fast-food | | |
| | | | | | Restaurant | | |
| 9:00 | | Yellow-white | | Customer 3 | 5 Fast-food | | Playing at the daycare |
| | | | | | Restaurant | | (21, 22) |
| 9:15 | | | | | 6 Fast-food | | |
| | | | | | Restaurant | | |
| 9:30 | | | | Customer 4 | 7 Fast-food | | |
| | | | | | Restaurant | | |
| 9:45 | | | | | 8 Fast-food | | |
| | | | | | Restaurant | | |
| 10:00 | | White | Budgerigar | | 1 Barber | | |
| 10:15 | | | | | 2 Barber | | |
| 10:30 | | | Window | | 3 Barber | | |
| 10:45 | | | | | 4 Barber | | |
| 11:00 | | | At the | Customer 1 | 5 Barber | | |
| | | | customer | | | | |
| 11:15 | | | | | 6 Barber | | |
| 11:30 | | | | Customer 2 | 7 Barber | | |
| 11:45 | | | | | 8 Barber | | |
| 12:00 | | Vertically white | | Customer 3 | 1 Fast-food | | Beppo's dining table (15, |
| | | | | | Restaurant | | 16), Playing at the |
| | | | | | | | daycare (21, 22) |
| 12:15 | | | | | 2 Fast-food | | |
| | | | | | Restaurant | | |
| 12:30 | | | | Customer 4 | 3 Fast-food | | |
| | | | | | Restaurant | | |
| 12:45 | | | | | 4 Fast-food | | |
| | | | | | Restaurant | | |
| 13:00 | | White | Budgerigar | | 5 Fast-food | | Beppo continues (15, 16) |
| | | | | | Restaurant | | |
| 13:15 | | | | | 6 Fast-food | | |
| | | | | | Restaurant | | |
| 13:30 | | | Window | | 7 Fast-food | | |
| | | | | | Restaurant | | |
| 13:45 | | | | | 8 Fast-food | | |
| | | | | | Restaurant | | |
| 14:00 | | | At the | Customer 1 | 1 Barber | | |
| | | | customer | | | | |
| 14:15 | | | | | 2 Barber | | |
| 14:30 | | | | Customer 2 | 3 Barber | | |
| 14:45 | | | | | 4 Barber | | |
| 15:00 | | | | Customer 3 | 5 Barber | | Playing at the day care, |
| | | | | | | | left (21, 22) |
| 15:15 | | | | | 6 Barber | | |
| 15:30 | | | | Customer 4 | 7 Barber | | |
| 15:45 | | | | | 8 Barber | | |
| 16:00 | | | Budgerigar | | 1 Fast-food | | |
| | | | | | Restaurant | | |
| 16:15 | | | | | 2 Fast-food | | |
| | | | | | Restaurant | | |
| 16:30 | | | Window | | 3 Fast-food | | |
| | | | | | Restaurant | | |
| 16:45 | | | | | 4 Fast-food | | |
| | | | | | Restaurant | | |
| 17:00 | | Yellow-white | At the | Customer 1 | 5 Fast-food | | Beppo End (15, 16) |
| | | | customer | | Restaurant | | |
| 17:15 | | | | | 6 Fast-food | | |
| | | | | | Restaurant | | |
| 17:30 | | | | Customer 2 | 7 Fast-food | | |
| | | | | | Restaurant | | |
| 17:45 | | | | | 8 Fast-food | | |
| | | | | | Restaurant | | |
| 18:00 | | | | Customer 3 | | On | Day care away (21, 22) |
| 18:30 | | | | Customer 4 | | | |
| 19:00 | | Red-yellow | Budgerigar | | | | Streetlight on (17, 18) |
| 19:30 | | | Window | | | | |
| 20:00 | | Red | | | | | House illumination on |
| | | | | | | | (19) |
| 21:00 | Weak | | | | | | |
| 22:00 | Quite weak | | | | | | |
| 23:00 | Off | | | | | | House illumination off |
| | | | | | | | (19) |

Implementation of the illustrated schedule in the embodiment shown in the drawings for a device for reproducing the current time leads to a constellation of ambient states which can be unambiguously assigned to any time of day. Special effects such as for example the illumination of a Christmas tree at Christmastime and activation of various effects of illumination and movement for the new year moreover lead to emphasis of seasonal ambient states.

1. Process for reproducing the current time using at least one reproduction element in which the state of the reproduction element is assigned to the current time, characterized in that the states of the reproduction elements reproduce the ambient states matched to the actual environment.

2. Process as claimed in claim 1, wherein the reproduction elements depending on the current time reproduce optical, acoustical, physical and/or scent effects.

3. Process as claimed in claim 1 or 2, wherein the reproduction elements at the same time reproduce time-assigned ambient situations depending on the current time.

4. Device for reproducing the current time with at least one reproduction element, the state of the reproduction elements being assigned to the current time, especially for implementing a process as claimed in one of claims 1 to 3, wherein the ambient states matched to the actual ambient states of the user can be reproduced by the reproduction elements (5, 6, 7, 9, 10, 11, 12, 15, 16, 17, 18, 19, 21, 22, 23, 26).

5. Device as claimed in claim 4, wherein there is a proximity sensor for activation of the reproduction elements (5, 6, 7, 9, 10, 11, 12, 15, 16, 17, 18, 19, 21, 22, 23, 26).

6. Device as claimed in claim 4 or 5, wherein there is a data interface for updating the EDP triggering of the reproduction elements (5, 6, 7, 9, 10, 11, 12, 15, 16, 17, 18, 19, 21, 22, 23, 26).

7. Device as claimed in one of claims 4 to 6, wherein the housing is made to be matched to the standard dimensions of the position for a record player of a HiFi rack.

8. Device as claimed in one of claims 4 to 6, wherein the housing is made to be adapted to wearing on an bracelet.
